(19) United States
(12) Patent Application Publication
(10) Pub. No.: US 2026/0267955 A1
(43) Pub. Date: Sep. 10, 2026

(54) KEY GENERATION DEVICE

(71) Applicant: Astemo, Ltd., Chiyoda-ku, Tokyo (JP)

(72) Inventors: Teruaki NOMURA, Hitachinaka-shi, Ibaraki (JP); Shugo MIKAMI, Hitachinaka-shi, Ibaraki (JP); Yasuhiro FUJII, Hitachinaka-shi, Ibaraki (JP); Mikio KATAOKA, Hitachinaka-shi, Ibaraki (JP)

(73) Assignee: Astemo, Ltd., Chiyoda-ku, Tokyo (JP)

(21) Appl. No.: 19/167,232

(22) PCT Filed: May 18, 2023
(86) PCT No.: PCT/JP2023/018582

§ 371 Date: Sep. 19, 2025

(51) Int. Cl. G06F 21/44; G06F 21/45

(52) U.S. Cl. CPC G06F 21/44; G06F 21/45

(57) ABSTRACT

A key generation device includes a verification unit that executes verification of a startup program, an acquisition unit that acquires an execution program from another device, and a key generation unit that generates a key for verifying the acquired execution program, in which the key generation unit generates the key after the startup program is verified.

### Technical Field

The present invention relates to a key generation device that generates a key for verifying a program to be executed.

### Background Art

In an electronic control unit (hereinafter also referred to as “ECU”) mounted on a vehicle, there is a technology of dynamically changing an arrangement of a program among a plurality of ECUs by generating a general-purpose program that can be executed even on different platforms in advance. However, easily executing a program received from a different ECU without verifying whether the program has been tampered with has a high security risk. For such a problem, there is secure boot or the like as a verification technique of the program.

PTL 1 discloses a secure boot method.

### Citation List

### Patent Literature

PTL 1: JP 2017-188826 A

### SUMMARY OF INVENTION

### Technical Problem

In order to check whether a program received from a different ECU has been tampered with and to authenticate whether a sender of the program is correct, it is desirable to verify the program by a method such as secure boot before executing the received program to ensure security.

Meanwhile, in a case where secure boot is executed, it is necessary to store a common encryption key in advance between ECUs that dynamically change the arrangement of programs. In this case, there is a problem that the management/operation cost of the encryption key increases, such as sharing of the encryption key among vendors of each ECU in advance, storage of the shared encryption key, and storage in the ECU. However, PTL 1 does not disclose a method for ensuring security without increasing the management/operation cost of the encryption key in the ECU that dynamically changes the arrangement of the program.

The present invention is intended to solve the above-mentioned problems, and an object thereof is to provide a technology capable of ensuring security of program dynamic arrangement between ECUS without increasing management/operation cost of an encryption key.

### Solution to Problem

In order to solve the above problem, a key generation device according to an embodiment of the present invention includes: a verification unit that executes verification of a startup program; an acquisition unit that acquires an execution program from another device; and a key generation unit that generates a key for verifying the acquired execution program, in which the key generation unit generates the key after the startup program is verified.

### Advantageous Effects of Invention

According to the present invention, it is possible to ensure security of program dynamic arrangement between ECUs without increasing the management/operation cost of the encryption key.

Further features related to the present invention will become apparent from the description of the present specification and the accompanying drawings. Problems, configurations, and effects other than those described above will be clarified by the following description of embodiments.

### BRIEF DESCRIPTION OF DRAWINGS

FIG. 1 is a block diagram illustrating an example of a functional configuration of an in-vehicle system on which a key generation device according to an embodiment is mounted.

FIG. 2 is a chart illustrating an example of program verification processing executed by a key generation device according to a first embodiment.

FIG. 3 is a chart illustrating an example of program verification processing executed by a key generation device according to a second embodiment.

FIG. 4 is a chart illustrating an example of program verification processing executed by a key generation device according to a third embodiment.

FIG. 5 is a diagram illustrating an example of a table used to calculate reliability of a session key illustrated in FIG. 4.

FIG. 6 is a chart illustrating an example of program verification processing executed by a key generation device according to a fourth embodiment.

FIG. 7 is a diagram illustrating an example of a table used for determining whether or not it is necessary to generate a session key illustrated in FIG. 6.

FIG. 8 is a chart illustrating an example of program verification processing executed by a key generation device according to a fifth embodiment.

### DESCRIPTION OF EMBODIMENTS

Hereinafter, embodiments of the present invention will be described with reference to the drawings. Note that configurations denoted by the same reference numerals in the respective embodiments have similar functions in the respective embodiments, and description thereof will be omitted unless otherwise specified.

### First Embodiment

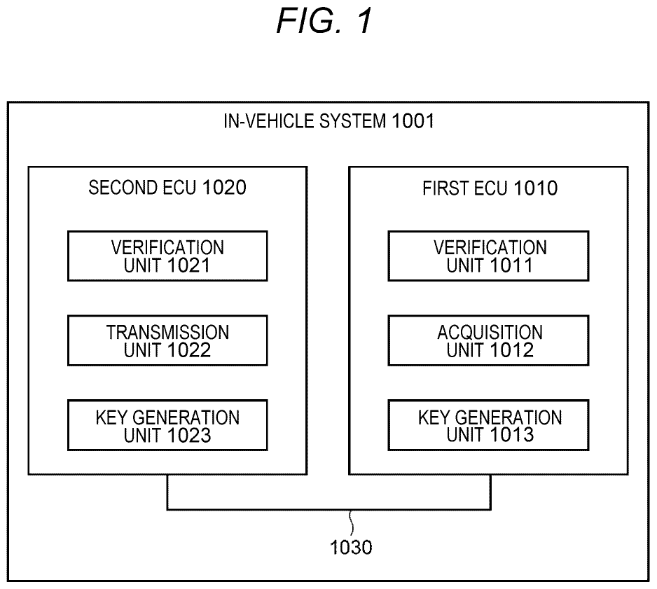

FIG. 1 is a block diagram illustrating an example of a functional configuration of an in-vehicle system 1001 on which a key generation device according to a first embodiment of the present invention is mounted. In the present embodiment, a case where the arrangement of programs is dynamically changed from a second ECU 1020 to a first ECU 1010 mounted in the in-vehicle system 1001 will be described as an example.

The first ECU 1010 and the second ECU 1020 are mounted on the in-vehicle system 1001. One ECU or a plurality of ECUs may be mounted. The first ECU 1010 is an example of a key generation device. The second ECU 1020 is an example of another device that delivers a program to the key generation device.

The first ECU 1010 and the second ECU 1020 are connected to each other by a communication bus 1030. The communication bus 1030 is used for data communication by an acquisition unit 1012 and a transmission unit 1022 described later. The communication standard of the communication bus 3 may be CAN, Ethernet, SPI, MII, LIN, or the like, and is not particularly limited.

Each ECU is constituted by a System On Chip (SoC) or a microcomputer, and includes a processor, a memory, a communication device, and the like. In addition, in order to safely execute processing related to security, each ECU preferably has a security chip such as a hardware security module (HSM).

The first ECU 1010 includes a verification unit 1011, the acquisition unit 1012, and a key generation unit 1013.

The verification unit 1011 is a functional unit that exhibits a function corresponding to the secure boot processing, and verifies the program when the first ECU 1010 is started up. For verification of the program, for example, a verification value is calculated from an encryption key stored in advance in the HSM and a verification target program by a specific encryption algorithm using the HSM, and determination is made based on whether the verification value matches a verification expected value calculated in advance. For verification of the program, a known encryption algorithm such as AES-CMAC can be used. In addition, the verification unit 1011 verifies a program (program whose arrangement is dynamically changed between ECUs, hereinafter referred to as a dynamic arrangement program) acquired by the acquisition unit 1012 to be described later using a verification expected value and a session key generated by the key generation unit 1013. In addition, it is determined whether or not to execute the received program based on the verification result.

The acquisition unit 1012 acquires the dynamic arrangement program from the second ECU 1020 via the communication bus 1030. In addition, the acquisition unit 1012 shares information generated by the key generation unit 1013 and the key generation unit 2023 to be described later among the ECUs via the communication bus 1030.

The key generation unit 1013 generates an encryption key for verifying the dynamic arrangement program acquired by the acquisition unit 1012. Specifically, the key generation unit 1103 generates a common session key with the second ECU 1020. For generation of the session key, for example, a known key sharing algorithm such as Diffie-Hellman (DH) or Elliptic curve Diffie-Hellman (ECDH) can be used.

As the key sharing algorithm, it is necessary to use an algorithm common to the key generation unit 1023 of the second ECU 1020, and the key sharing algorithm may be exchanged in advance at the time of design, or may be determined by performing handshake before the key sharing timing. By dynamically generating the encryption key (session key) after the completion of the secure boot processing using the key sharing algorithm, it is not necessary to store a common encryption key (common key) between the ECUs in advance, and the management/operation cost of the encryption key does not increase.

Furthermore, in the present embodiment, the key generation unit 1013 generates the session key after the verification unit 1011 executes program verification (secure boot processing) at the time of startup of the ECU. By generating the session key after the secure boot, key sharing between the ECUs can be performed in a state where the first ECU 1010 and the second ECU 1020 are not tampered with, so that the generated session key is highly reliable. By using such a highly reliable session key, it is possible to more securely verify the acquired program.

The second ECU 1020 includes a verification unit 1021, the transmission unit 1022, and the key generation unit 1023.

The verification unit 1021 verifies the program when the second ECU 1020 is started up, similarly to the verification unit 1011 of the first ECU.

The transmission unit 1022 transmits the dynamic arrangement program to the first ECU 1010. In addition to the dynamic arrangement program, a verification expected value calculated for the dynamic arrangement program is transmitted to the first ECU 1010 by using a session key generated by the key generation unit 1023 described later.

Similarly to the key generation unit 1013, the key generation unit 1023 generates the session key common to the first ECU 1010. In addition, the verification expected value of the dynamic arrangement program transmitted by the transmission unit 1022 is generated using the generated session key. A known encryption algorithm such as AES-CMAC can be used to generate the verification expected value of the program. In addition, the encryption algorithm to be used needs to be common to the encryption algorithm used by the verification unit 1021.

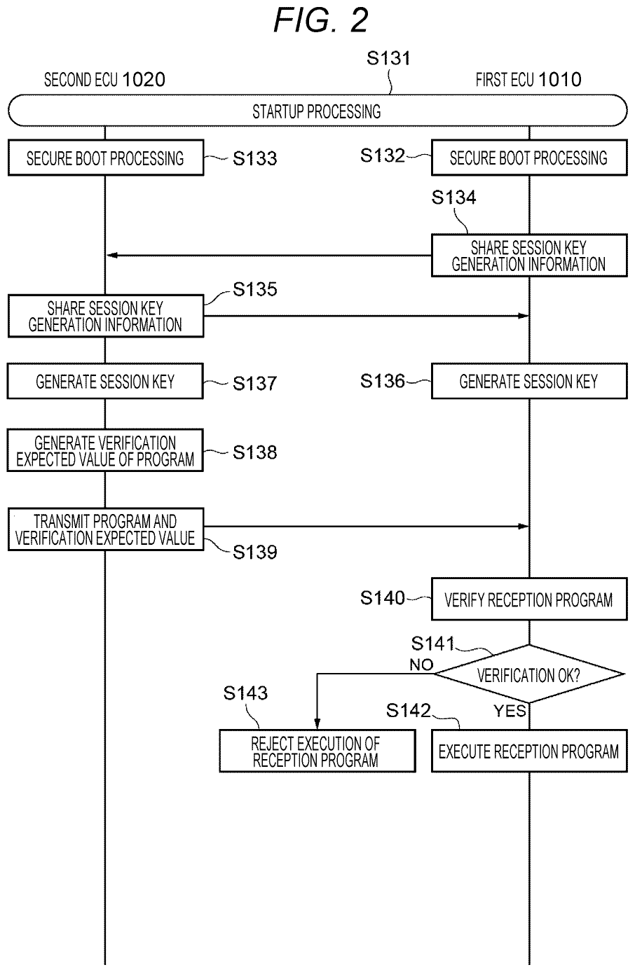

Hereinafter, an example of program verification processing executed by the key generation device according to the present embodiment will be described with reference to FIGS. 2 to 6.

FIG. 2 is a diagram illustrating a flow example of program verification processing executed by the key generation device according to the first embodiment.

The verification processing of the dynamic arrangement program illustrated in FIG. 2 is started when the first and second ECUs 1010 and 1020 shift to the startup state (S131). At this time, both ECUs are not necessarily started up at the same time. Each microcomputer of the ECU causes the verification unit 1011 or the verification unit 1021 to perform secure boot processing at the time of the startup, and executes a startup program when its own startup program has not been tampered with (S132, S133).

Next, after the secure boot processing is normally completed, the first ECU 1010 creates information (session key generation information) for generating the session key by the key generation unit 1013 and transmits the information to the second ECU 1020 (S134). Similarly, after the secure boot processing is normally completed, the second ECU 1020 also creates session key generation information by the key generation unit 1023 and transmits the session key generation information to the first ECU 1010.

In each ECU, the key generation unit 1013 or the key generation unit 1023 generates a common session key based on the session key generation information created and shared in S134 and S135 (S136, S137).

Next, the second ECU 1020 generates the verification expected value of the dynamic arrangement program using the generated session key in the key generation unit 1023 (S138). In addition, the dynamic arrangement program and the verification expected value are transmitted by the transmission unit 1022 to the first ECU 1010 via the communication bus 1030 (S139).

In the first ECU 1010, in the acquisition unit 1012, the verification unit 1011 verifies the acquired dynamic arrangement program using the session key generated by the first ECU 1010 and the verification expected value received from the second ECU 1020 (S140). When the verification of the dynamic arrangement program is successful (“YES” in S141), the received program is executed (S142). When the verification of the dynamic arrangement program has failed (“NO” in S141), the received program is not executed, and the processing ends (S143).

The program verification processing according to the first embodiment has been described above, and in particular, the session key generation in S136 and S137 is performed after the execution (completion) of the secure boot processing in S131 and S132. That the secure boot processing is completed means that the ECU is not exposed to an attack from a third party and is highly likely to be secured, so that the key generated immediately after the secure boot processing is also highly reliable. Therefore, the session key generated in common between the ECUs is highly reliable, and authentication of the dynamic arrangement program delivered from the second ECU 1020 to the first ECU by the key can be made very secure.

### Second Embodiment

Next, a key generation device according to a second embodiment will be described. The functional configuration of the key generation device according to the second embodiment is similar to that of the first embodiment, and illustration and description thereof are omitted. The same applies to other embodiments described later.

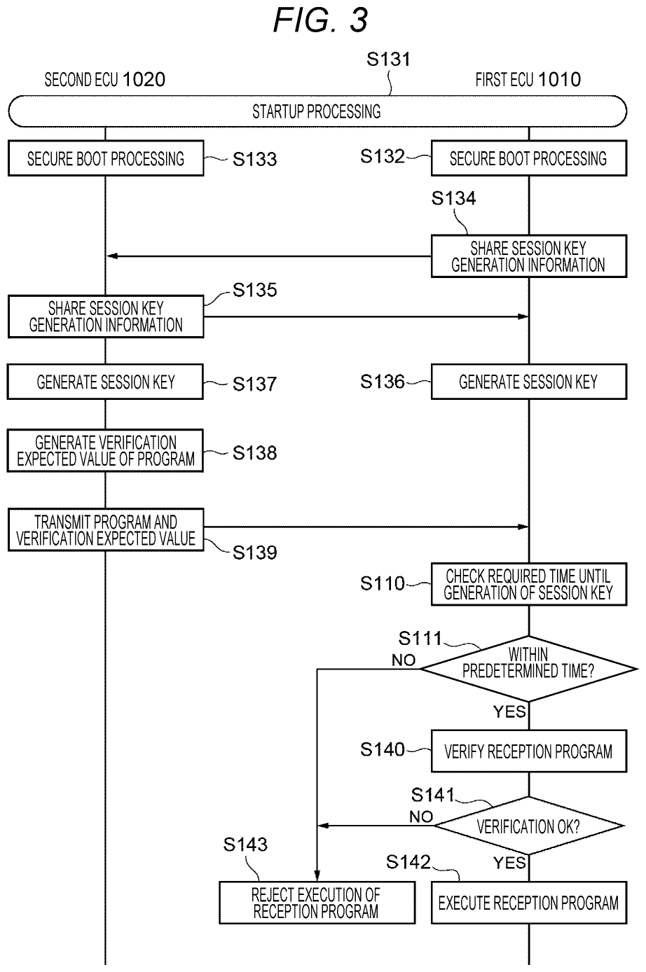

FIG. 3 is a diagram illustrating a flow example of program verification processing executed by the key generation device according to the second embodiment. Note that the flow illustrated in FIG. 3 is obtained by adding branch processing based on the required time from the completion of the secure boot processing to the generation of the session key to the flow illustrated in FIG. 2, and other processing is similar to the flow illustrated in FIG. 2. Therefore, differences from FIG. 2 will be mainly described below.

After generating the session key in S136, the key generation unit 1013 of the first ECU 1010 checks the required time from completion of the secure boot processing to generation of the session key (S110). It is determined whether the required time is within a predetermined time (S141), and when the required time is within the predetermined time, the reception program is verified (S140). This point is the same as in the first embodiment. When the time required for generation of the session key exceeds the predetermined time in S111 (“NO” in S111), it is determined that second ECU 1020 behaves differently from a steady state, and the received program is not executed (S143). That is, during the secure boot processing and the session key generation information sharing, it is determined that there is a high possibility of unauthorized access from a third party to the second ECU 1020 and there is a possibility that the reception program has been tampered with, and the program is discarded. As a result, it is possible to ensure a more secure key sharing and execution environment of the dynamic arrangement program.

### Third Embodiment

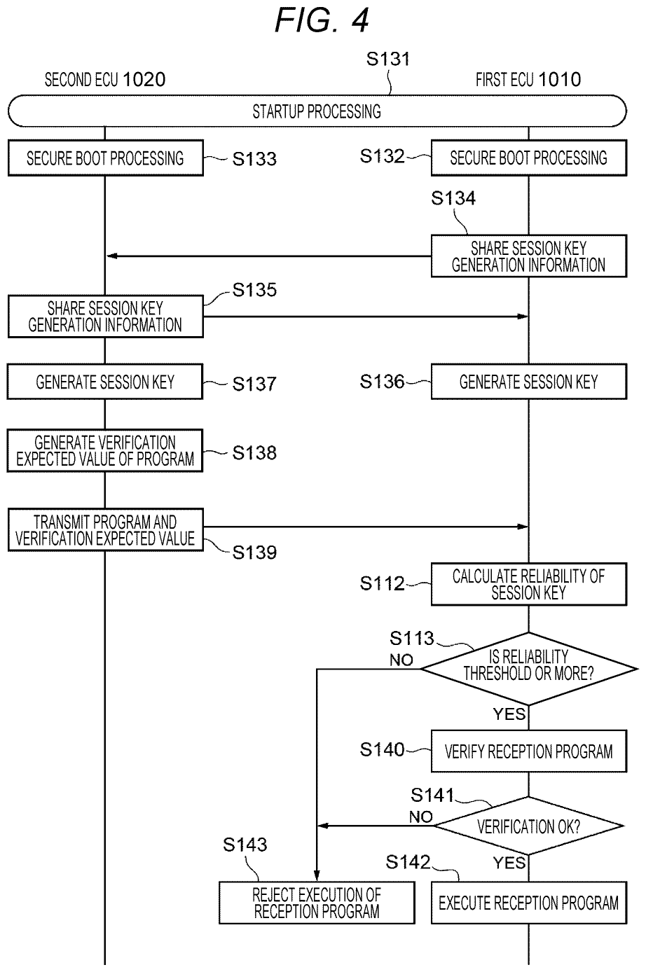

FIG. 4 is a diagram illustrating a flow example of program verification processing according to a third embodiment. The flow illustrated in FIG. 4 is obtained by adding branch processing based on the reliability of the generated session key in the flow illustrated in FIG. 2.

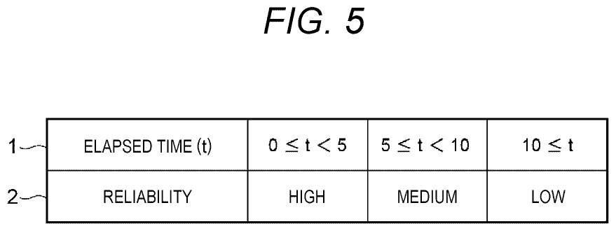

After the key generation unit 1013 of the first ECU 1010 generates the session key in S136, the key generation unit 1013 calculates the reliability of the session key according to the elapsed time from the completion of the secure boot processing (S112). For example, in the calculation of the reliability, the table illustrated in FIG. 5 may be stored in the first ECU 1010 in advance and referred to at the time of calculating the reliability in the key generation unit 1013. In FIG. 5, an elapsed time 1 indicates an elapsed time from the completion of the secure boot processing, and a reliability 2 indicates the reliability of the session key. FIG. 5 illustrates an example of a table in which the reliability 2 is classified into “high”, “medium”, and “low” based on the elapsed time 1. When the reliability 2 calculated based on the table of FIG. 5 is lower than the predetermined threshold (“NO” in S113), for example, when the threshold is set to “medium” and the reliability 2 is “low”, the received program is not executed (S143). By determining whether to execute the received program based on the reliability of the generated session key, it is possible to guarantee more secure key sharing and an execution environment of the dynamic arrangement program.

### Fourth Embodiment

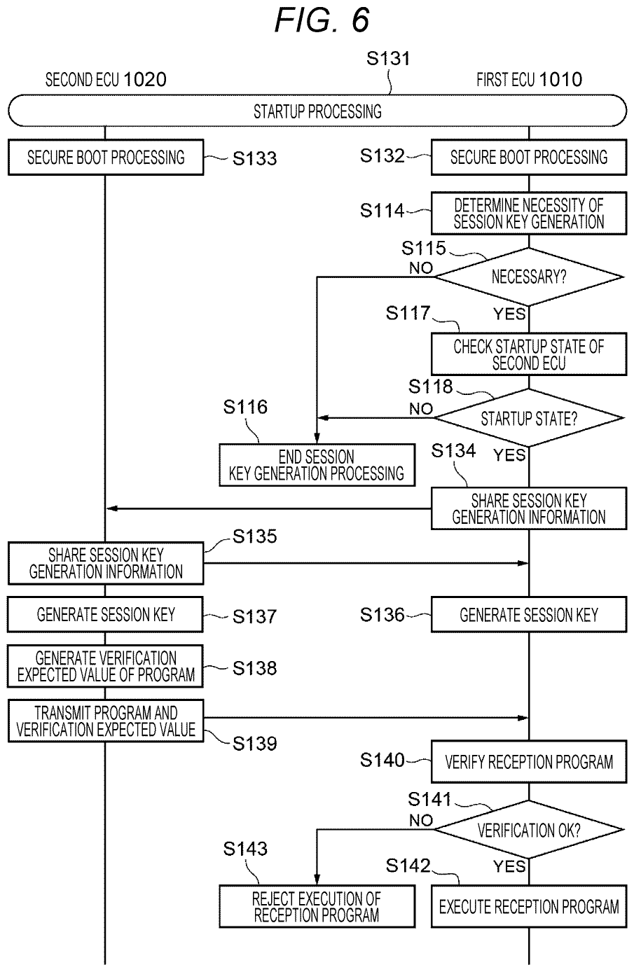

FIG. 6 is a diagram illustrating a flow example of program verification processing according fourth embodiment. Note that the flow illustrated in FIG. 6 is obtained by adding branch processing based on necessity determination of session key generation in the flow illustrated in FIG. 2.

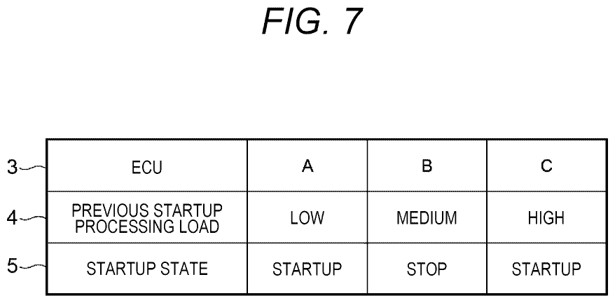

The key generation unit 1013 of the first ECU 1010 performs the necessity determination of session key generation after executing the secure boot processing in S132 (S114). For example, the table illustrated in FIG. 7 may be stored in the first ECU 1010 in advance, and the necessity determination of the session key generation may be used for the necessity determination of the session key generation in the key generation unit 1013. In FIG. 7, the ECU3 corresponds to the second ECU 1020. A previous startup processing load 4 indicates a processing load in a previous startup cycle in each ECU3. A startup state 5 indicates whether startup information is received from the ECU3 in the current startup cycle, and indicates whether the startup of the ECU3 is completed. The startup information may be a network management (NM) frame in a case where the communication bus 1030 is the CAN.

The key generation unit 1013 of the first ECU 1010 determines with which ECU3 a session key needs to be generated in the current startup cycle based on the previous startup processing load 4 (S114). Specifically, when the previous startup processing load is “high”, it means that a high load is applied to the ECU3 at the previous startup. Therefore, it is determined that the program needs to be dynamically arranged in order to distribute the load, that is, the session key needs to be generated. When the previous startup processing load of the ECU3 (second ECU 1020) is “low” or “medium”, it means that the ECU3 can withstand an additional arithmetic processing load, and thus, it is determined that there is no need to dynamically arrange the program, and the session key generation processing is ended (“No” in S115→S116).

When the key generation unit 1013 specifies the ECU3 for which the session key needs to be generated (“YES” in S115), the startup state 5 of the ECU3 (the specified second ECU 1020) is checked (S117). When it is checked that the startup state 5 is started up (“YES” in S118), the session key is generated with the specified ECU3 (S134 to S137). On the other hand, when the startup state 5 is stopped (“NO” in S118), the subsequent program verification processing is skipped (S116).

In this manner, by identifying a target for which a session key is to be generated, checking the startup state, and grasping a timing at which a session key can be generated, consumption of unnecessary calculation resources can be reduced.

### Fifth Embodiment

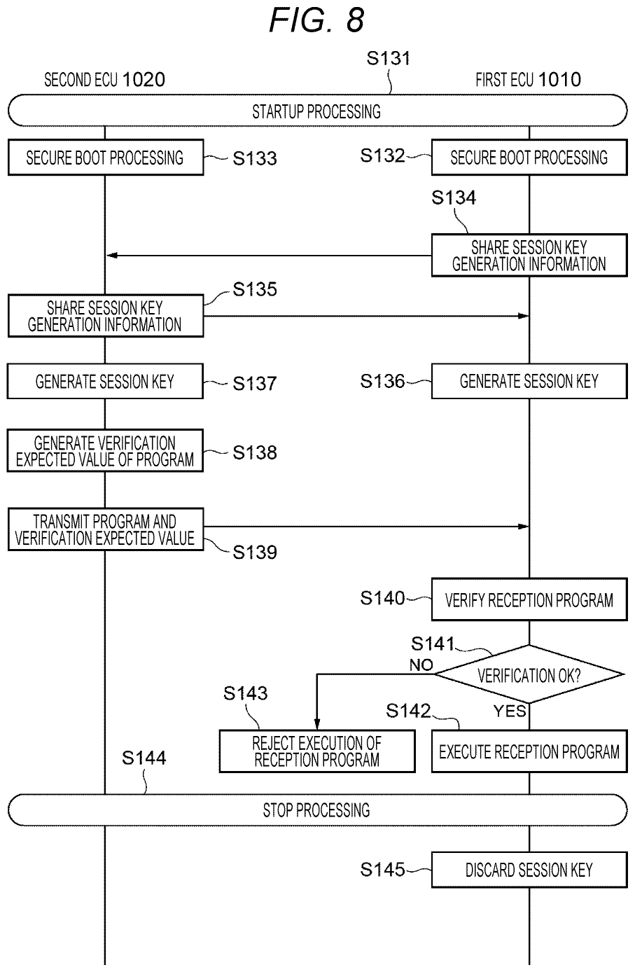

FIG. 8 is a diagram illustrating a flow example of program verification processing according to a fifth embodiment. Note that the flow illustrated in FIG. 8 is obtained by adding session key discard to the flow illustrated in FIG. 2.

In FIG. 8, after the program verification processing ends (S142, S143), the key generation unit 1013 of the first ECU 1010 discards the session key in response to the stop processing (S144) (S145). The stop processing (S144) may be, for example, turning off an ignition switch of an automobile such as IG-OFF. Further, the session key may be discarded (S145) when it is determined that the session key is no longer needed in the startup cycle. By generating and discarding the session key for each startup cycle, more secure key sharing and an execution environment of the dynamic arrangement program can be ensured. Furthermore, for example, in a case where it can be determined that the session key has been compromised in a certain startup cycle, the session key generation unit 1013 may generate the session key again.

According to the embodiments of the present invention described above, the following operational effects are obtained.
(1) A key generation device according to an embodiment of the present invention includes: a verification unit that executes verification of a startup program; an acquisition unit that acquires an execution program from another device; and a key generation unit that generates a key for verifying the acquired execution program, in which the key generation unit generates the key after the startup program is verified.

With the above configuration, it is possible to secure the security of the program dynamic arrangement between the ECUs without increasing the management/operation cost of the encryption key.
(2) The verification unit verifies the acquired execution program using the key. The generated key is actually used to ensure the usefulness of the present invention.
(3) The key generation unit generates the key within a predetermined time after the startup program is verified. It is determined that the key generated after the lapse of the predetermined time is highly likely to be affected by the cyberattack by the third party, and the key is not used, whereby the safety can be secured.
(4) The key generation unit generates the key after a startup program of the other device is verified. Even when the key is generated before the startup program of the other device is verified, the generated key is wasted in a case where the startup program of the other device fails in verification. Therefore, it is preferable to generate the key after the startup program of the other device is verified as described above.
(5) The key generation unit sets reliability of the key according to an elapsed time from verification of the startup program to the generation of the key. By using the key only when the reliability of the generated key is a predetermined threshold or more, it is possible to secure safety as in (3).
(6) The key generation unit specifies the other device and generates the key after acquiring startup information of the other device. There is a case where it is not necessary to generate the key depending on the startup information of the other device, and it is preferable to acquire and confirm startup information of the other device in advance as described above in order to avoid generation of a wasted key.
(7) The key generation unit discards the key at a predetermined trigger including power-off of an in-vehicle device on which the key generation device is mounted. In this way, a new key is generated for each startup cycle, and it is possible to avoid key compromise due to crossing between cycles.

### Others

Note that the present invention is not limited to the above embodiments, and includes various modifications. For example, the above-described embodiments have been described in detail in order to describe the present invention in an easy-to-understand manner, and are not necessarily limited to those having all the described configurations. Further, a part of the configuration of one embodiment can be replaced with the configuration of another embodiment, and the configuration of another embodiment can be added to the configuration of one embodiment. In addition, it is possible to add, delete, and replace other configurations for a part of the configuration of each embodiment.

In addition, some or all of the above-described configurations, functions, processing units, processing means, and the like may be realized by hardware, for example, by designing with an integrated circuit. In addition, each of the above-described configurations, functions, and the like may be realized by software by a processor interpreting and executing a program for realizing each function. Information such as a program, a tape, and a file for realizing each function can be stored in a recording device such as a memory, a hard disk, and a solid state drive (SSD), or a recording medium such as an IC card, an SD card, and a DVD.

In addition, the control lines and the information lines indicate what is considered to be necessary for the description, and do not necessarily indicate all the control lines and the information lines on the product. In practice, it may be considered that almost all the configurations are connected to each other.

### Reference Signs List

1010 first ECU (key generation device)
1011 verification unit
1012 acquisition unit
1013 key generation unit
1020 second ECU (another device)
1030 communication bus

1. A key generation device comprising:
a verification unit that executes verification of a startup program;
an acquisition unit that acquires an execution program from another device; and
a key generation unit that generates a key for verifying the acquired execution program,
wherein the key generation unit generates the key after the startup program is verified.

2. The key generation device according to claim 1, wherein the verification unit verifies the acquired execution program using the key.

3. The key generation device according to claim 1, wherein the key generation unit generates the key within a predetermined time after the startup program is verified.

4. The key generation device according to claim 1, wherein the key generation unit generates the key after a startup program of the other device is verified.

5. The key generation device according to claim 1, wherein the key generation unit sets reliability of the key according to an elapsed time from verification of the startup program to generation of the key.

6. The key generation device according to claim 1, wherein the key generation unit specifies the other device and generates the key after acquiring startup information of the other device.

7. The key generation device according to claim 1, wherein the key generation unit discards the key at a predetermined trigger including power-off of an in-vehicle device on which the key generation device is mounted.
